(19) United States
(12) Patent Application Publication
(10) Pub. No.: US 2009/0257374 A1
(43) Pub. Date: Oct. 15, 2009

(54) MOBILE MULTIMEDIA TERMINAL FOR A CALM SYSTEM AND A METHOD FOR OFFERING CONTINUOUS MULTIMEDIA COMMUNICATIONS

(75) Inventors: Han Byeog Cho, Daejeon (KR); Kyong Ho Kim, Daejeon (KR); Jong-Suk Chae, Daejeon (KR); Chul Sik Yoon, Daejeon (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATIONS RESEARCH INSTITUTE, Daejeon (KR)

(21) Appl. No.: 12/307,209

(22) PCT Filed: Dec. 29, 2006
(86) PCT No.: PCT/KR2006/005888

§ 371 Date: Dec. 31, 2008

(30) Foreign Application Priority Data
Aug. 29, 2006 (KR) 10-2006-0082339

(51) Int. Cl. H04W 4/00

(52) U.S. Cl. 370/328

(57) ABSTRACT

A mobile multimedia terminal for a CALM (Continuous Air interface for Long and Medium range) system includes, a wireless multimedia communications transceiver for transmitting and receiving signals over at least two wireless media; a communications link determination and management unit for acquiring interface IDs of the wireless media over which the wireless multimedia communications transceiver receives wireless multimedia signals and establishing communications channels for each of the wireless media whose interface IDs are acquired; and a wireless communications control unit for controlling the communications link determination and management unit to acquire the interface IDs and establish the communications channels, and for controlling data transmission and receipt via the established channels.

### TECHNICAL FIELD

The present invention relates to a CALM (Continuous Air interface for Long and Medium range) system; and more particularly, to a mobile multimedia terminal for use in a CALM system and a method capable of offering continuous multimedia communications, wherein the terminal can perform continuous communications for ITS (Intelligent Transportation Systems) while changing wireless medium therefor among a cellular/GSM (Global System for Mobile communications) service, a WiBro/mobile WiMAX (wireless Internet) service, and a WLAN (Wireless Local Area Networks) service.

### BACKGROUND ART

Due to the development of Telematics services, a car becomes a third Internet space succeeding offices and home. Further, in cooperation with home networks and office automation via wired/wireless communications and broadcast networks by using intelligent terminals, Telematics services are providing a car driver with seamless communications services which have been provided to a user in offices or at home.

As for air interfaces related standards in Telematics systems, standardization works are now on progress for a 2.5th and 3rd generation CDMA cellular system, a CALM system for DSRC (Dedicated Short-Range Communications), a wireless LAN system, wireless or mobile Internet (e.g., IEEE 802.16e standard such as WiBro, mobile WiMAX or the like), and DMB (Digital Multimedia Broadcasting) system by respective standardization groups.

FIG. 1 is a diagram showing the architecture of a typical CALM system proposed by ISO TC204 WG16.

In a CALM system, several media are incorporated to provide a variety of wireless communication services, as shown in FIG. 1. To be specific, an integrated wireless platform for the CALM system has been studied and developed to provide continuous communications to a user even in a moving car by using a variety of wireless communications services such as an ITS (Intelligent Transportation System) service, a WiBro or a Mobile WiMAX (wireless Internet) service, WLAN service, and an IR (Infrared) communications service, etc.

### DISCLOSURE OF INVENTION

### Technical Problem

It is, therefore, an object of the present invention to provide a mobile multimedia terminal for a CALM system, wherein the terminal supports a plurality of wireless multimedia services such as a cellular/GSM, a wireless Internet, and a WLAN service and performs seamless communications by selecting one of the wireless media.

It is another object of the present invention to provide a method for offering continuous multimedia communications in a mobile multimedia terminal for a CALM system, wherein the terminal supports a plurality of wireless multimedia services such as a cellular, a wireless Internet, and a WLAN service and performs seamless communications by selecting one of the wireless media.

### Technical Solution

In accordance with one aspect of the present invention, there is provided a mobile multimedia terminal for a CALM (Continuous Air interface for Long and Medium range) system, the terminal including:

a wireless multimedia communications transceiver for transmitting and receiving signals over at least two wireless media;

a communications link determination and management unit for acquiring interface IDs of the wireless media over which the wireless multimedia communications transceiver receives wireless multimedia signals and establishing communications channels for each of the wireless media whose interface IDs are acquired; and

a wireless communications control unit for controlling the communications link determination and management unit to acquire the interface IDs and establish the communications channels, and for controlling data transmission and receipt via the established channels.

In accordance with another aspect of the present invention, there is provided a method for providing at least two wireless media communications services among WLAN, cellular/GSM, wireless Internet, infrared, millimeter-wave, and PAN by using a mobile multimedia terminal for a CALM system, the method including the steps of:

acquiring interface IDs of wireless media over which the mobile multimedia terminal receives wireless multimedia signals;

determining wireless media, each having one of the acquired interface IDs assigned thereto;

establishing a communications channel for each one of the determined wireless media;

transmitting and receiving communications data via the established communications channel; and

changing the communications channel to new one whenever there is a multimedia signal newly received during the wireless media service.

### Advantageous Effects

In accordance with the present invention, the terminal for the CALM system supports the WLAN, the WiBro, and the cellular services, and offers continuous multimedia communications by selecting one of the communications services.

In accordance with the present invention, wireless multimedia communications are controlled by using ITS applications (for collecting, providing and managing transportation information) and interface IDs of wireless media such as cellular and wireless Internet media. Thus, it is possible to provide continuous wireless communications services even in a moving car or any area in a long and medium range.

### BRIEF DESCRIPTION OF THE DRAWINGS

The above and other objects and features of the present invention will become apparent from the following description of preferred embodiments given in conjunction with the accompanying drawings, in which:

FIG. 1 is a diagram showing the architecture of a typical CALM system proposed by ISO TC204 WG16;

FIG. 2 is a schematic configuration view showing a mobile multimedia terminal for a CALM system in accordance with the present invention;

FIG. 3 is a block diagram showing the CALM architecture dedicated to a mobile multimedia terminal in accordance with the present invention;

FIG. 4 is a detailed block diagram showing a media determining part and a media managing part in the CALM architecture applied to a mobile multimedia terminal in accordance with the present invention;

FIG. 5 is a diagram showing an initialization procedure of acquiring interface IDs of wireless media in a media determining unit of a mobile multimedia terminal in accordance with the present invention; and

FIG. 6 is a flowchart showing a continuous multimedia communications process using a mobile multimedia terminal for a CALM system in accordance with the present invention.

### BEST MODE FOR CARRYING OUT THE INVENTION

Hereinafter, preferred embodiments of the present invention will be described in detail with reference to the accompanying drawings.

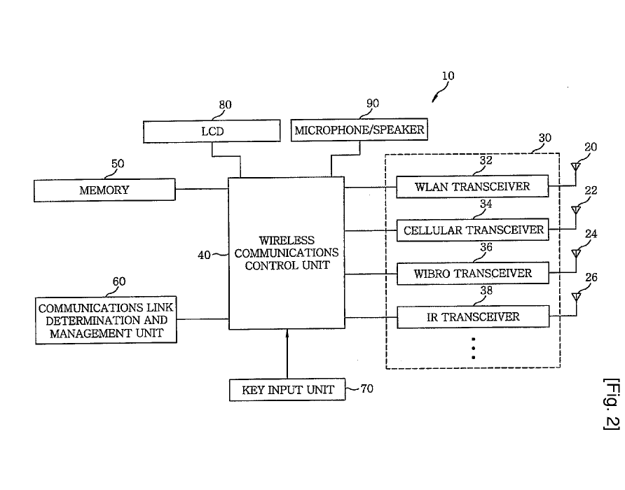

FIG. 2 is a schematic configuration view showing a mobile multimedia terminal for a CALM system in accordance with the present invention.

Referring to FIG. 2, in order to realize a variety of wireless multimedia communications at one terminal, the mobile multimedia terminal 10 includes, a plurality of antennas 20, 22, 24, and 26; a wireless multimedia communications transceiver 30; a wireless communications control unit 40; a memory 50; a communications link determination and management unit 60; a key input unit 70; a display unit 80; and a microphone/speaker 90.

The wireless multimedia communications transceiver 30 transmits and receives signals over several wireless media via the antennas 20, 22, 24 and 26. For example, the wireless multimedia communications transceiver 30 includes, a WLAN (wireless LAN) communications transceiver 32; a cellular communications transceiver 34 (e.g., for CDMA or GSM); a WiBro (wireless Internet) communications transceiver 36; an IR (infrared) communications transceiver 38; a millimeter-wave communications transceiver (not shown); a PAN (Personal Area Network) communications transceiver (not shown), and the like.

When the terminal is powered on, the wireless communications control unit 40 controls the communications link determination and management unit 60 to perform an initialization procedure (i.e., acquiring interface IDs of wireless media over which the wireless multimedia communications transceiver 30 receives wireless multimedia signals). And then, the wireless communications control unit 40 compares the interface IDs acquired via the communications link determination and management unit 60 to IDs stored in the memory 50 to determine wireless media having the acquired interface IDs assigned thereto, and controls the communications link determination and management unit 60 to establish communications channels for each of the wireless media via a CAL (Communications Adaptation Layer). In order to perform continuous wireless multimedia communications over wireless media, the terminal is designed to select a wireless media communications service having a priority settled by a user, e.g., by employing a selection switch changeable between a manual mode and an automatic mode. Therefore, in response to a selected wireless communications service mode (e.g., a manual mode or an automatic mode) and user-preset priorities of wireless communications services, the wireless communications control unit 40 controls to provide the wireless media communications service having the priority accordingly. For example, if the user sets the wireless communications service mode as the automatic mode and the priorities are preset as in the order of a WLAN, a WiBro, and a cellular service, the wireless communications control unit 40 controls to perform continuous communications in that order.

The memory 50 stores therein interface IDs each being assigned to the respective wireless media (e.g., the WLAN, the WiBro, the cellular, and the IR media) uniquely. The memory 50 also stores a program for checking whose interface IDs are acquired among the wireless media and performing communications over the wireless media whose interface IDs are acquired via the CAL.

The communications link determination and management unit 60 acquires interface IDs of wireless media (e.g., WLAN, WiBro and cellular media), and establishes communications channels for each of the wireless media whose interface IDs are acquired. Further, it manages to transmit management data and application data separately over the wireless media.

The key input unit 70 receives a variety of key signals (e.g., character, numeral, and function key signals) for operating the mobile multimedia terminal, and sends the received key signals to the wireless communications control unit 40.

The display unit 80 (e.g., an LCD device) displays an operational state of the mobile multimedia terminal, application programs, and the like under control of the wireless communications control unit 40.

The microphone/speaker 90 is used for inputting voice signals to the mobile multimedia terminal and outputting voice signals under control of the wireless communications control unit 40.

In this manner, in the mobile multimedia terminal 10 for the CALM system in accordance with the present invention, when the terminal is powered on by receiving the power key signal from the key input unit 70, the wireless communications control unit 40 controls the communications link determination and management unit 60 to perform the above-described initialization procedure. And then, the wireless communications control unit 40 checks whose interface IDs among wireless media are acquired via the communications link determination and management unit 60, and controls the communications link determination and management unit 60 to establish communications channels for each of the wireless media whose interface IDs are acquired. According to the wireless communications service mode set by the user and user-preset priorities of wireless communications services, the communications link determination and management unit 60 manages the communications via the established communications channels to be continuous by using the CAL. Thus, continuous wireless multimedia communications via the media communications transceiver 30 can be achieved.

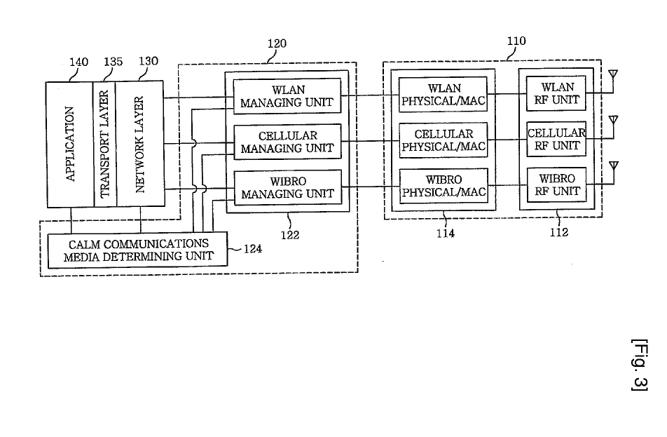

FIG. 3 is a schematic block diagram showing the CALM architecture dedicated to a mobile multimedia terminal in accordance with the present invention.

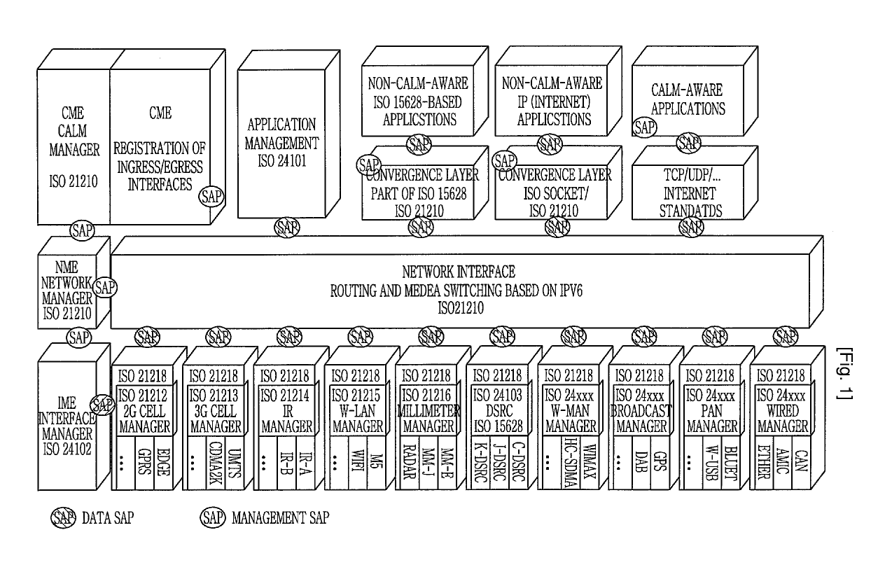

As shown in FIG. 3, the CALM system dedicated to the mobile multimedia terminal in accordance with the present invention has, for example, the architecture proposed by the ISO TC204 WG16 (see FIG. 1) to support a variety of wireless multimedia communications interfaces and protocols.

A wireless multimedia communications transceiver 110 having the CALM architecture includes a multimedia RF communications unit 112 and a multimedia physical/MAC layer digital unit 114. The multimedia RF communications unit 112 includes, for example, a WLAN RF communications unit, a cellular RF communications unit, and a WiBro RF communications unit. The multimedia physical/MAC layer digital unit 114 includes a WLAN physical/MAC layer digital unit, a cellular physical/MAC layer digital unit, and a WiBro physical/MAC layer digital unit.

The communications link determination and management unit 120 includes a CALM communication media determining unit 124 for determining the interface IDs of the wireless media by checking signals received over wireless media; and a media managing unit 122 for separating management data and application data of the wireless media each identified by interface ID thereof and sending the data to the wireless multimedia communications transceiver 110 via communications channels each assigned to one of the wireless media by the CALM communications media determining unit 124.

The mobile multimedia terminal adopts the CALM architecture to connect applications 140 (such as Non-CALM aware, CALM aware and the like) to a network layer 130 and the CALM communications media determining unit 124 via a transport layer 135. The network layer 130 includes network interfaces such as a convergence layer, TCP/UDP Internet standards and IPv6, and is connected to the CAL.

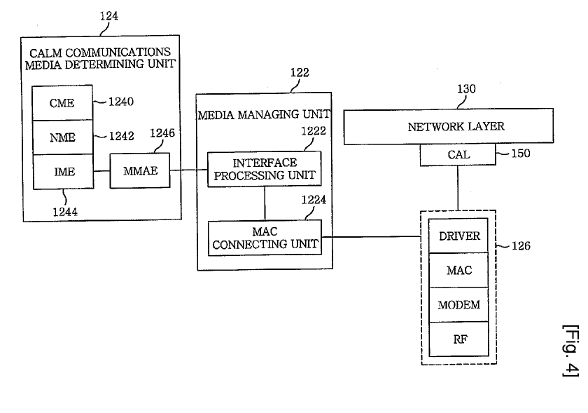

FIG. 4 is a detailed block diagram showing a media determining part and a media managing part in the CALM architecture applied to a mobile multimedia terminal in accordance with the present invention.

As shown in FIG. 4, the CALM communication media determining unit 124 and a media managing unit 122 of the mobile multimedia terminal in accordance with the present invention perform a wireless communications connection, networking of the wireless media, and application data and management data transmission.

The CALM communications media determining unit 124 having the CALM architecture sets several media interface information (i.e., IDs) for continuous wireless multimedia communications. Specifically, the CALM communications media determining unit 124 includes a CME (CALM Management Entity) 1240, an NME (Network Management Entity) 1242, an IME (Interface Management Entity) 1244, and a MMAE (Media Management Adaptation Entity) 1246.

The CME 1240 performs optimal media communications selection and policy management, system situation reception, system initialization, and the like. The NME 1242 detects signals for searching valid media and notifies the CME 1240 of the valid media. The IME 1244 sets media information for routing to an optimal medium among the valid media. The MMAE 1246 transmits the set media information (i.e., interface ID).

The media managing unit 122 having the CALM architecture establishes a connection with a communications device for data transmission over a wireless medium corresponding to the interface ID set by the CALM communications media determining unit 124. The media managing unit 122 includes an interface processing unit 1222 and a MAC connecting unit 1224.

In the media managing unit 122, the interface processing unit 1222 interfaces with the MMAE 1246 and is connected to the MAC connecting unit 1224 to perform the initialization procedure (i.e., acquisition of the interface IDs). Further, if the MAC connecting unit 1224 receives a new signal from a base station, it informs the interface processing unit 1222 of such signal change. The interface processing unit 1222 sends the signal change to the CME 1240 via the IME 1244 and the NME 1242. Moreover, the interface processing unit 1222 controls the MAC connecting unit 1224 to establish and manage a separate wireless media communications channel for data transmission over each medium identified by the interface ID.

Data for data communications between applications are sent from the network layer 130 to a lower layer via the CAL 150. The data are transmitted and received via a data transmission channel 126 (including a device driver, a MAC, a modem, and an RF) corresponding to the interface ID specified by a media selection process.

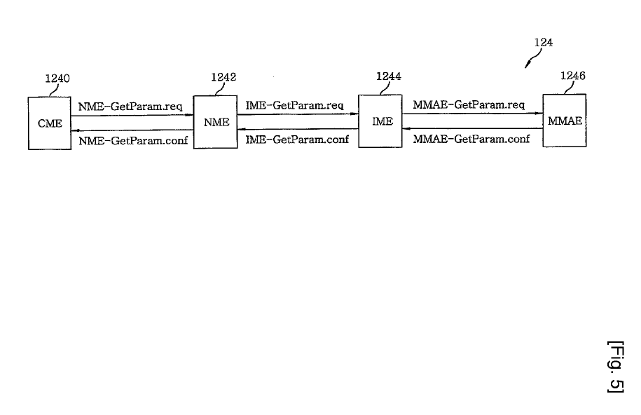

FIG. 5 is a diagram showing an initialization procedure of acquiring interface IDs of wireless media in a media determining unit of a mobile multimedia terminal in accordance with the present invention.

As shown in FIG. 5, the CALM communications media determining unit 124 performs a communications procedure between management entities in order to acquire an interface ID of a wireless medium in a CALM communications initialization procedure.

Specifically, the CALM communications media determining unit 124 acquires the media interface information for the CALM communications initialization procedure as follows: an interface information acquisition request command is delivered from the CME 1240 to the MMAE 1246 via the NME 1242 and the IME 1244, and then media information in the MMAE 1246 is delivered to the CME 1240 via the NME 1242 and IME 1244.

More specifically, the CME 1240 sends an NME-GetParam.req command to the NME 1242, and then the NME 1242 sends an IME-GetParam.req command to the IME 1244. The IME 1244 then sends an MMAE-GetParam.req command to the MMAE 1246, and finally, the MMAE 1246 acquires wireless media communications parameter information (i.e., interface ID).

The MMAE 1246 sends the acquired wireless media parameter information to the IM 1244 by using the MMAE-GetParam.conf, and then the IME 1244 sends the wireless media parameter information to the NME 1242 by using the IME-GetParam.conf. The NME 1242 then sends the wireless media parameter information to the CME 1240 via the NME-GetParam.conf.

In this manner, the CALM communications media determining unit 124 performs an initialization procedure in which the CME 1240 acquires interface ID of each wireless medium through the communications among the management entities CME, NME, IME, and MMAE 1240, 1242, 1244, and 1246 of the CALM system.

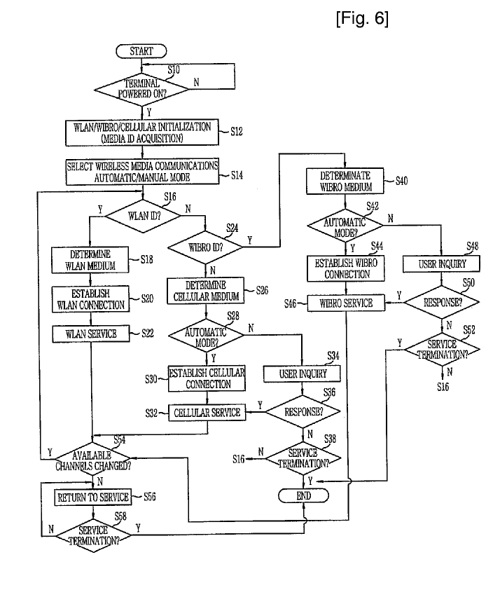

FIG. 6 is a flowchart showing a continuous multimedia communications process using a mobile multimedia terminal for a CALM system in accordance with the present invention.

With reference to FIG. 6 along with FIG. 3, a handover process, which is for continuous communications, among wireless multimedia communications services (e.g., WLAN, WiBro, and cellular service) is performed in the manner as follows.

First, a mobile multimedia terminal for the CALM system determines whether the terminal is powered on (step S10).

If the terminal is powered on, the wireless communication control unit 40 in the terminal performs an initialization procedure in which communications signals of wireless media such as WLAN, WiBro, and cellular media are received via the wireless multimedia communications transceiver 110, and interface IDs of the wireless media are acquired via the CALM communications media determining unit 124 in the communications link determination and management unit 120 by using the received wireless media communication signal (step S12). To be specific, the CALM communications media determining unit 124 in the communications link determination and management unit 120 acquires the interface IDs via the management entities such as CME, NME, IME, and MMAE.

Thereafter, the control unit in the terminal determines whether a user-preset wireless communications service mode is in a manual or an automatic mode (step S14). Here, the automatic mode implies that a communications connection is automatically established via wireless communications service such as WiBro or cellular service in an area where WLAN service is not available, for example. Further, the manual mode implies that such communications connection is established according to a response from a user.

The control unit of the terminal determines whether the interface ID acquired by the CALM communications media determining unit 124 is a WLAN interface ID by using the media managing unit 122, for example, in order to establish a WLAN communications connection (step S16).

If the interface ID is the WLAN interface ID, the control unit assigns (establishes) a WLAN media communications channel by using the media managing unit 122 and selects a WLAN media communications connection manner (steps S18 to S20).

The control unit controls to offer the WLAN communications service via the physical/MAC and the RF unit in the wireless multimedia communications transceiver 110 by using the CAL (step S22).

If the acquired interface ID is not the WLAN interface ID, the control unit determines whether the interface ID acquired via the media managing unit 122 is a Wibro interface ID (step S24).

If the acquired interface ID is not the Wibro interface ID, the control unit determines it as a cellular interface ID and determines whether the preset wireless communications service mode is the automatic mode (step S26 to S28)

If the wireless communications service mode is the automatic mode, the control unit assigns (establishes) a cellular media communications channel by using the media managing unit 122 and selects a cellular media communications connection manner (step S30).

The control unit controls to offer the cellular communications service via the physical/MAC and the RF unit in the wireless multimedia communications transceiver 110 by using the CAL (step S32).

If, however, the wireless communications service mode is in the manual mode, the control unit sends a user inquiry to a user via the wireless multimedia communications transceiver 110 and determines whether there is a response from the user (steps S34 to S36).

If the response is received via the wireless multimedia communications transceiver 110, the control unit performs the cellular communications service as in the step S32. Otherwise, the control unit determines whether to terminate the service or to return to the step S16 (step S38).

On the other hand, if the acquired interface ID is the Wibro interface ID, the control unit determines the interface ID as the WiBro media by using the media managing unit 122 and determines whether the preset wireless communications service mode is in the automatic mode (steps S40 to S42).

If the preset wireless communications service mode is the automatic mode, the control unit assigns (establishes) a WiBro media communications channel and selects a Wibro media communications connection manner by using the media managing unit 122 (step S44).

The control unit controls to offer the WiBro communications service via the physical/MAC and the RF unit in the wireless multimedia communications transceiver 110 by using the CAL (step S46).

If the wireless communications service mode is in the manual mode, the control unit sends a user inquiry to the user via the wireless multimedia communications transceiver 110 and determines whether there is a response from the user (steps S48 to S50).

If the response is received via the wireless multimedia communications transceiver 110, the control unit performs the WiBro communications service as in step S46. If there is no response, the control unit determines whether a service termination key signal is input via the key input unit (step S52), and then the control unit terminates the service or returns to the step S16.

Further, in order to perform a seamless handover process among the WLAN, WiBro, and cellular service, the control unit periodically checks and updates available channels during a wireless communications service (step S54).

If the available channels are changed, the control unit notifies the CALM communications media determining unit 120 of the change, thereby returning to step S16 to perform a new media communications establishing process. If the available channels are not changed, the control unit controls to continue to offer the ongoing wireless communications service as in the step S22, S32 or S46 (step S56).

During the wireless communications service in the step S22, S32 or S46, the control unit determines whether a service termination key signal is received via the key input unit (step S58), and then terminates the service or continues to offer the wireless communication service.

In this manner, in the method for offering continuous multimedia communications services by using the mobile multimedia terminal for the CALM system in accordance with the present invention, the interface ID for wireless multimedia communications such as WLAN, WiBro, and cellular multimedia communications is acquired, and then it is checked which medium the acquired interface ID indicates. Subsequently, a communications media corresponding to the interface ID is determined to establish a communication channel, and a communications with the wireless media is then performed via the CAL.

While the invention has been shown and described with respect to the preferred embodiments, it will be understood by those skilled in the art that various changes and modifications may be made without departing from the scope of the invention as defined in the following claims.

1. A mobile multimedia terminal for a CALM (Continuous Air interface for Long and Medium range) system, the terminal comprising:
a wireless multimedia communications transceiver for transmitting and receiving signals over at least two wireless media;
a communications link determination and management unit for acquiring interface IDs of the wireless media over which the wireless multimedia communications transceiver receives wireless multimedia signals and establishing communications channels for each of the wireless media whose interface IDs are acquired; and
a wireless communications control unit for controlling the communications link determination and management unit to acquire the interface IDs and establish the communications channels, and for controlling data transmission and receipt via the established channels.

2. The mobile multimedia terminal of claim 1, wherein the wireless multimedia communications transceiver transmits and receives signals over at least two wireless media among WLAN (wireless LAN), cellular/GSM (Global System for Mobile communications), wireless Internet, infrared, millimeter-wave, and PAN (Personal Area Network).

3. The mobile multimedia terminal of claim 1, wherein the communications link determination and management unit includes a media determining unit for acquiring the interface IDs of the wireless media; and wherein the media determining unit has a CME (CALM Management Entity), an NME (Network Management Entity), an IME (Interface Management Entity), and an MMAE (Media Management Adaptation Entity) through which the interface IDs are acquired.

4. The mobile multimedia terminal of claim 1, wherein the communications link determination and management unit includes a media managing unit for establishing the communications channels for each of the wireless media whose interface IDs are acquired, and receiving and transmitting management information of the medium for transmissions of application data.

5. The mobile multimedia terminal of claim 1, further comprising a selection switch to select a wireless media communication service having a priority by a user, wherein the wireless communications control unit controls to provide the wireless media communication service having a priority in response to the selection switch

6. The mobile multimedia terminal of claim 5, wherein the wireless communications control unit automatically offers other wireless communications service over other wireless media, if the wireless communications service having the priority is not available.

7. The mobile multimedia terminal of claim 1, the terminal further comprising a memory for storing therein the interface IDs, each being assigned to the respective wireless media uniquely.

8. A method for providing at least two wireless media communications services among WLAN, cellular/GSM, wireless Internet, infrared, millimeter-wave, and PAN by using a mobile multimedia terminal for a CALM system, the method comprising the steps of:
acquiring interface IDs of wireless media over which the mobile multimedia terminal receives wireless multimedia signals;
determining wireless media, each having one of the acquired interface IDs assigned thereto;
establishing a communications channel for each one of the determined wireless media;
transmitting and receiving communications data via the established communications channel; and
changing the communication channel to new one whenever there is a multimedia signal newly received during the wireless media service.

9. The method of claim 8, wherein the interface IDs of wireless media are acquired via CME, NME, IME, and MMAE in the CALM architecture.

10. The method of claim 8, further comprising the step of setting a wireless communications service mode as either a manual or an automatic mode.

11. The method of claim 10, wherein the method further comprises:
transmitting an inquiry signal to a user and offering a wireless communications service over a wireless media corresponding to a response from the user, if the wireless communications service mode is set as the manual mode.

12. The method of claim 10, wherein the method further comprises:
offering a wireless communications service over a wireless medium having a specific priority, if the wireless communications service mode is set as the automatic mode and a wireless communications service is not available over a wireless medium having a priority higher than the specific priority.
